(19) United States
(12) Patent Application Publication
(10) Pub. No.: US 2012/0192804 A1
(43) Pub. Date: Aug. 2, 2012

(54) CAT GROOMING POST

(76) Inventor: David Haaf, San Rafael, CA (US)

(21) Appl. No.: 13/015,468

(22) Filed: Jan. 27, 2011

(51) Int. Cl. A01K 13/00

(52) U.S. Cl. 119/621

(57) ABSTRACT

A cat grooming device which includes a base configured to reside upon a horizontal surface to support a grooming post extending vertically therefrom. The base is provided with a bottom surface for residing upon the horizontal surface and a top surface, the top surface having a material for collecting and retaining fur emanating from a cat while engaging the grooming post. The grooming post has a grooming surface extending substantially its entire length, the grooming surface being in the form of a plurality of pliable nodules capable of grooming a cat when the cat contacts the nodules during use of the device

### TECHNICAL FIELD

The present invention involves a cat grooming post primarily intended to groom a domestic cat together with a surface for retaining fur emanating from a cat while engaging the present device

### BACKGROUND OF THE INVENTION

It is quite important for the health and well being of a pet cat to provide proper grooming. Often times, cats try to clean themselves and spend a good deal of time licking their fur and paws However, external grooming is also highly recommended as grooming accomplishes much more than providing a healthy coat. It also stimulates circulation, removes loose hair and helps prevent matting

There are many grooming devices in the marketplace designed to groom a domestic cat There are a plethora of brushes, combs and the like used for this purpose, examples of which are disclosed in U.S. Pat. Nos. 676,358; 2,660,183; 2,865,039; 2,881,460; 3,059,259 and 6,513,457. A number of grooming and scratching implements designed for use by domestic cats are disclosed in U.S. Pat. No. 7,444,959 including a scratching post in the form of a cylindrical member extending vertically from a rectangular base U.S. Pat. No. 5,842,440 discloses a self grooming aid for cats in the form of a circular base and extending shaft It is thought that the cat can stand on the base with its head or body at the level of the brush for facilitating grooming.

Unfortunately, prior art self grooming devices such as those disclosed in the art cited above have not been universally embraced Without exception, self grooming posts such as that disclosed in the ‘440 patent employ bristles which cats often times find abrasive and, as a consequence, tend to avoid such grooming aids. Further, cats which do self groom create loose hair and dander which must be dealt with on a regular basis Unless trapped or immediately cleaned, cat fur and dander disburses resulting in an unkept and often times nonhygienic area.

It is thus an object of the present invention to provide a cat grooming device which overcomes the limitation of the prior art.

These and further objects will be more readily appreciated when considering the following disclosure and appended claims.

### SUMMARY OF THE INVENTION

A cat grooming device which includes a base configured to reside upon a horizontal surface to support a grooming post extending vertically therefrom. The base is provided with a bottom surface for residing upon the horizontal surface and a top surface, the top surface having a material for collecting and retaining cat fur emanating from a cat while engaging the grooming post. The grooming post has a grooming surface extending substantially its entire length, the grooming surface being in the form of a plurality of pliable nodules capable of grooming a cat when the cat contacts the nodules during use of the device.

### BRIEF DESCRIPTION OF THE FIGURES

FIG. 1 is a perspective view of the cat grooming device of the present invention.

FIG. 2 is a partial plan view illustrating the grooming nodules suitable for use herein.

FIGS. 3 and 4 are views of suitable bases having alternative fur and dander capturing media situated thereon.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

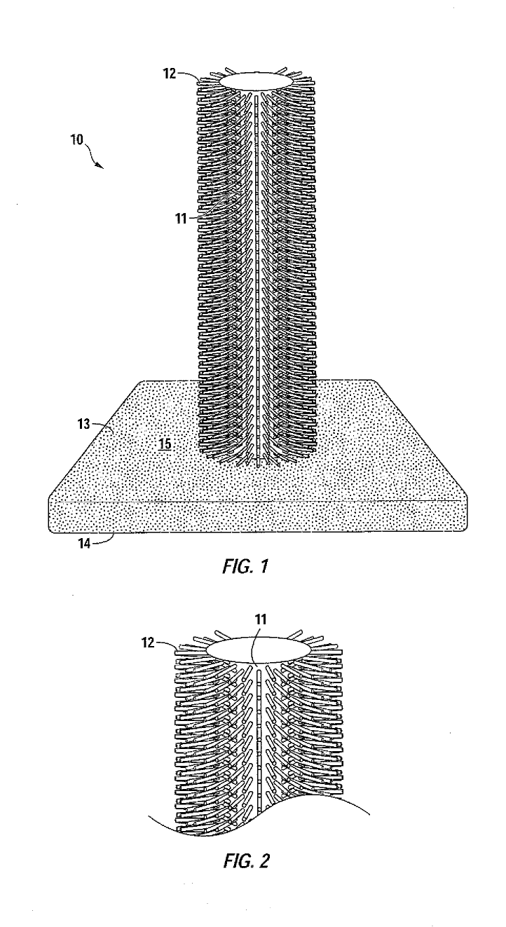

Turning first to FIG. 1, cat grooming device 10 is illustrated. This device comprises base 13 configured to reside upon a substantially horizontal surface by interfacing bottom 14 therewith. Grooming post 11 is then caused to project vertically from base 13 and can be either permanently fixed thereto or can be attached by, for example, a screw/bolt arrangement through base 13 and extending upward within post 11 to enable post 11 to be removed from base 13 for cleaning and replacement.

Post 11 comprises a grooming surface extending substantially the entire length thereof. The grooming surface is in the form of a plurality of pliable nodules 12 which are intended to be flexible to encourage grooming. These nodules are comprised of thermoplastic resin which are soft to the touch, pliable and easier to clean than traditional bristles. In fact one could quite easily vacuum cat fin and dander from the surface of post 11 to restore it to its original condition. Thus, nodules 12 are rubber-like cylindrically shaped elements which are of a sufficient length to penetrate a cat's fur and yet be soft and pliable enough so as not to abrade the cat's skin for if it was to do so, cats would avoid this device, generally. Ideally, the nodules are composed of a thermoplastic resin in the form of nubs of consistent size, shape, diameter and durometer.

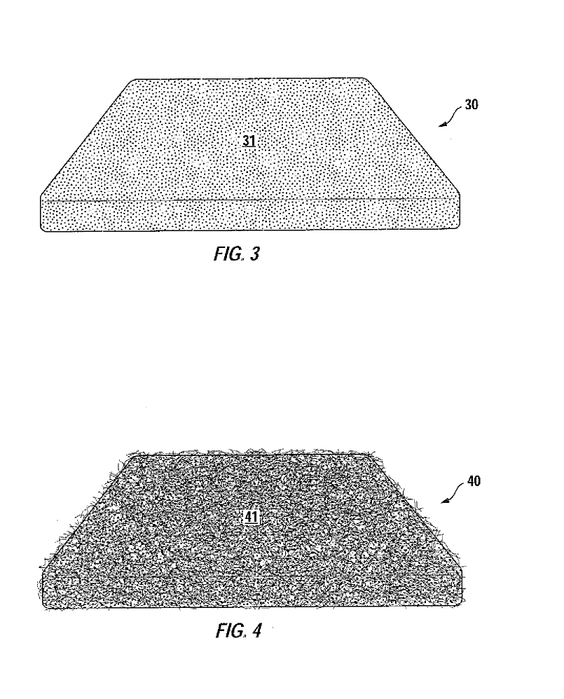

As noted previously, grooming post 11 is intended to reside and extend vertically from base 13. The top surface of base 13 is intended to be of a material capable of removing and trapping animal fur Two ideal materials capable of performing this function are shown in FIGS. 3 and 4.

Turning to FIG. 3, base 30 is shown having top surface 31 in the form of directional microfiber. Generally, directional microfiber refers to synthetic fibers that measure less than one denier, the most common type being made from polyesters, polyamides such as nylon, Kevlar, Nomex and trogamide or a conjugation of polyester and polyamide. Directional microfibers feel somewhat smooth when stroked in a first direction but resistant to movement when stroked in the opposite direction.

In turning to FIG. 4, base 40 is shown with a layer of unwoven fibers such as unwoven polyester fibers which are disclosed in U.S. Pat. No. 5,363,804, the disclosure which is incorporated by reference herein. Such fibers are naturally electrostatic (cationic) and, thus, cat hair and dander would tend to cling to such a material

In summary, the benefits of the present invention become quite apparent Grooming post 11 supporting flexible nodules 12 promotes grooming. Its surface also acts to trap a good deal of the animal fur resulting from grooming. The surface can be easily cleaned by vacuum or similar expedient by the pet owner. Fur dander and the like which is not trapped by nodules 12 fall to base 13, the later displaying surfaces 15, 31 or 41 which also acts to trap fur and dander. Thus, a grooming device has been disclosed which a cat would enjoy using and yet, through the sum of its parts, results in a clean, tidy and hygienic expedient likely to be embraced by any cat owner seeking to minimize debris inherently created during the grooming process.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described.

Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. A cat grooming device comprising a base configured to reside upon a substantially horizontal surface to support a grooming post extending vertically therefrom, said base having a bottom surface for residing upon said substantially horizontal surface and a top surface, said top surface having a material for collecting and retaining fur emanating from a cat engaging said grooming post, said grooming post comprising a grooming surface extending substantially the entire length of said grooming post, said grooming surface comprising a plurality of cylindrically shaped pliable nodules of thermoplastic resin in the form of nubs of consistent size, shape and durometer capable of grooming a cat when said cat contacts said nodules during use of said device.

2. (canceled)

3. The cat grooming device of claim 1 wherein said material for collecting and retaining cat fur comprises directional microfiber.

4. The cat grooming device of claim 1 wherein said material for collecting and retaining cat fur comprises unwoven polyester fiber.
